(19) United States
(12) Patent Application Publication
(10) Pub. No.: US 2005/0079335 A1
(43) Pub. Date: Apr. 14, 2005

(54) Reinforcing-thermoplastic mat and method of forming such a mat

(76) Inventor: Rodney R. Wilkins, Granville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/933,998

(22) Filed: Sep. 3, 2004

Related U.S. Application Data
(63) Continuation-in-part of application No. 10/685,096, filed on Oct. 10, 2003.

(51) Int. Cl. B32B 7/02

(52) U.S. Cl. 428/292.1

(57) ABSTRACT

A method of forming a mixed fiber mat comprising forming a multi-layer mat from a first substantially planar structure of reinforcing fibers, such as a continuous strand fiberglass mat, and a first layer of thermoplastic fibers, such as polypropylene fibers. The multi-layer mat is subsequently needle-punched to intertwine the fibers. The mixed fiber mat preferably comprises a first continuous strand glass fiber mat and a first layer of thermoplastic fibers needle-punched together to intertwine the fibers. The mixed fiber mat can be heated to melt the thermoplastic fibers and then cooled to harden the thermoplastic to form a matrix. A composite is formed by this heating and cooling process. Other fibers can be substituted for the glass and polypropylene fibers.

### BACKGROUND OF THE INVENTION

1. Field of the Invention

This invention relates generally to the field of mixed fiber mats, and to a method of forming a mat of reinforcing fibers and thermoplastic fibers and the mat so formed.

2. Description of the Related Art

A composite material is formed from reinforcing members, such as fibers, in a matrix that surrounds the reinforcing members. The combination of the characteristics of each of the components gives the composite advantages over the components. A well-known composite is made of very thin glass fibers in an epoxy or other flexible matrix material. Such fiberglass composites are known to be strong and resilient.

It is also known that the raw material for forming composites can be combined during a single process, and can be formed subsequently into a finished composite. For example, U.S. Pat. No. 5,316,561 to Roncato et al. teaches to form a combination of glass reinforcing fibers and organic fiber material that will form the matrix of the composite upon completion of manufacturing. The manufacturing process includes placing the fibers in a mold and compressing them at a high temperature. This high pressure and temperature melts the organic fibers and the liquefied or semi-liquid fiber material flows around the glass fibers to form a matrix around the glass fibers. The result, after cooling, is a composite part in the shape of the mold.

One difficulty with composites is that because they are made of two different materials, there is heterogeneity in the finished product. This can have a deleterious effect on the surface qualities of the composite. Some composites are only acceptable as sub-surface reinforcing members due to the poor surface quality that results on their exterior surface.

The prior art, including the Roncato patent, describes composite raw materials that have disadvantages in at least the surface quality of the finished product. Therefore, there is a need for a raw material, and a method of making that material, that can be formed into a composite that has acceptable surface quality as well as traditional composite reinforcement properties.

### BRIEF SUMMARY OF THE INVENTION

The invention is a method of forming a mixed fiber mat, and the mixed fiber mat. The method comprises the steps of forming a multi-layer mat from a first substantially planar structure of reinforcing fibers, such as a continuous strand glass fiber mat, and a first layer of thermoplastic fibers and needle-punching the multi-layer mat to intertwine the fibers. The preferred thermoplastic fibers are staple polypropylene fibers, which are also referred to as chopped or discontinuous fibers. In a preferred method, staple polypropylene fibers are disposed on a first side of a continuous strand glass fiber mat, and in a more preferred method, staple polypropylene fibers are disposed on a second, opposite side of the continuous strand glass fiber mat.

The invention also contemplates a mixed fiber mat comprising a first continuous strand glass fiber mat and a first layer of thermoplastic fibers needle-punched together to intertwine the fibers. The preferred mixed fiber mat has thermoplastic fibers that are polypropylene fibers, and in a more preferred mixed fiber mat, another layer of staple polypropylene fibers is disposed on a second, opposite side of the continuous strand glass fiber mat.

### BRIEF DESCRIPTION OF THE SEVERAL VIEWS OF THE DRAWINGS

FIG. 1 is a schematic side view of an apparatus for practicing the method and forming the mixed fiber mat of the present invention.

FIG. 2 is a schematic side view of a mixed fiber mat according to the present invention.

FIG. 3 is a schematic side view of an alternative mixed fiber mat according to the present invention.

FIG. 4 is a schematic side view of an alternative mixed fiber mat according to the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

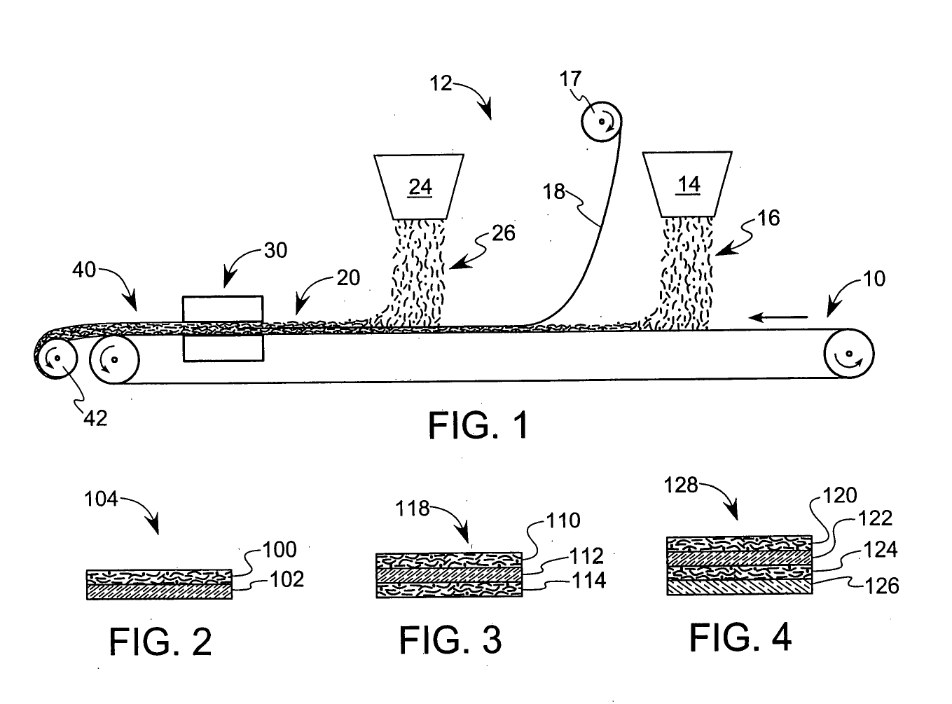

The preferred apparatus for forming the raw material for a composite is shown schematically in FIG. 1. The conveyor 10 operates in a conventional manner to move material from one location to another while passing through a workspace 12. The workspace 12 includes at least one device that dispenses staple fibers onto the conveyor below. This device is preferably a carding apparatus 14 that takes staple fibers from a tightly packed form, commonly referred to as a “bale”, removes the fibers from the bale and dispenses the fibers 16 in a loosely packed form onto the conveyor 10.

The fibers 16 are thermoplastic fibers that will melt at elevated temperature, and then harden upon cooling. One type of thermoplastic fiber that has proven satisfactory is polypropylene staple fibers having a denier of 6 (six) and a length of about two inches. Of course, fibers having other or mixed dimensions can be used as will become apparent to a person of ordinary skill in the art. Additionally, other thermoplastic fibers are contemplated as being substitutes for the polypropylene fibers. For example, acrylic based fibers, nylon type fibers, polyester fibers, polyethylene fibers and bi-component fibers known as “binder fibers” can all be used in place of the preferred polypropylene fibers described above. The sizes of these fibers are preferably similar to the size of the polypropylene fibers discussed above, although a person of ordinary skill will recognize that various characteristics of the different fibers will affect the range of possible sizes. Likewise, a blend of many of these fibers or any other thermoplastic fibers can be used. It will become apparent that virtually any thermoplastic fiber or blend of two or more thermoplastic fibers, can be used.

The thermoplastic fibers 16 are preferably dispensed onto the conveyor 10 at one position, and a substantially planar structure of reinforcing fibers, such as the fiberglass mat 18, is fed onto the conveyor 10 just downstream from the carding apparatus 14. The terms “upstream” and “downstream” as used herein are relative terms relating to the stream of flow on the conveyor 10, which is from right to left in FIG. 1. Thus, the right end of the conveyor 10 is upstream of the left end of the conveyor 10 in FIG. 1.

The fiberglass mat 18 is a reinforcing mat made of a continuous strand fiberglass mat that can be formed by one of many different conventional methods. One method for making fiberglass mats is described in several patents to Modigliani, U.S. Pat. Nos. 2,546,230; 2,609,320; and 2,964,439, all of which are incorporated herein by reference. These patents disclose an apparatus in which a slowly reciprocating, melting furnace feeds molten glass through spinning orifices which discharge an array of fine, continuous glass filaments or fibers that are wrapped circumferentially around a rapidly rotating drawing drum. The melting furnace reciprocates relatively slowly in a longitudinal direction above the drum's rapidly rotating circumferential surface, thereby forming a build-up of continuous fibers oriented at acute angles with one another. During winding of the fibers on the rotating drum, a binder, such as a thermosetting resin, is commonly applied by spraying the fibers already deposited on the drum to bind the fibers at their overlapping junctions with fibers of previously deposited layers.

After a suitable thickness of fibers has been created, the condensed mat is removed from the drum by forming a longitudinal cut through the mat parallel with the axis of the drum. The mat so formed can be used in the process shown in FIG. 1, although this is not preferred due to the short length of such a mat. Also, the density of this mat is extremely high. However, the condensed mat is a continuous strand fiberglass mat, and thus could be used in the present invention.

More preferably, the condensed mat is subsequently modified in a conventional manner by being deposited on a conveyor belt that moves at a very slow rate. The condensed mat is generally rectangular in shape, and the fibers in the mat extend, due to the orientation of the rectangular mat on the conveyor, substantially completely across the width of the mat substantially perpendicular to the direction of movement of the conveyor belt. At the exit end of the conveyor belt, a retarding roller presses the condensed mat against the conveyor belt, which is supported by an oppositely rotating support roller. The leading end of the condensed mat beyond the retarding roller is stretched or expanded longitudinally up to hundreds of times its original, condensed length. The expanding is a continuous process with the leading end being pulled longitudinally while the retarding roller/support roller structure minimizes the forward movement of the remaining length of the condensed mat.

As the mat expands longitudinally, it also expands (“fluffs”) in the direction of the mat's thickness to a consistency resembling cotton candy. Additionally, during the expansion of the mat, the fibers that are originally oriented transversely to the direction of movement are pulled longitudinally, thereby tending to rotate and reorient the fibers to a 45 degree or greater angle with respect to the longitudinal direction. During the expansion process, in which the original mat increases in length enormously and “fluffs” to a significantly greater thickness, the mat necks down to a smaller width.

After the majority of the expanding takes place, the fluffed, expanded mat is compressed in the direction of its thickness by rolling and it is heated by radiant heaters to set the thermosetting resin incorporated during the winding of the fibers on the drum. Thereafter, the stretched glass fiber mat is wound on a spool, such as the spool 17 to which the mat 18 is wound in FIG. 1. Thus, the mat 18, which is much longer than the condensed mat prepared in the Modigliani process alone, and has had its fibers severed once along the axis of the forming drum, is a continuous strand fiberglass mat, because the condensed mat from which it is derived was formed from continuous strands of glass.

The continuous strand fiberglass mat 18 does not have to be made by the Modigliani process. Any process or apparatus that forms a mat from one or more continuous strands of glass fiber will work. An example of another such process is the “air laid” process.

The mat 18 is fed onto the conveyor 10 on top of the layer of fibers 16 that is dispensed from the carding apparatus 14. This forms a two-layer mat with fibers 16 on the bottom and a continuous strand fiberglass mat on the top. Of course, the two could be reversed, but for reasons that will be apparent to the person of ordinary skill, this is not preferred.

Downstream of the position on the conveyor 10 at which the mat 18 is fed onto the conveyor 10, another device, preferably the carding apparatus 24, dispenses staple thermoplastic fibers 26 onto the conveyor 10. The fibers 26, which are preferably polypropylene fibers essentially the same as the fibers 16, preferably fall from the carding apparatus 24, which is preferably substantively identical to the carding apparatus 14, onto the upper surface of the mat 18 to form a layer thereon. Thus, the resulting product on the conveyor 10 downstream of the carding apparatus 24 is a mat 20 made of two layers of staple polypropylene fibers 16 and 26 on opposite sides of a continuous strand fiberglass mat 18.

The mat 20 is conveyed downstream further to a loom 30 that needle-punches the mat 20 to intertwine the staple fibers 16 and 26 with the continuous strand fiberglass fibers of the mat 18. The mat 40 is conveyed out of the loom 30, and is a unitary structure that retains its shape to the extent that it is capable of being formed, cut, and wound on a reel 42.

It is contemplated that once a sufficient amount of mat 40 is wound on the reel 42, the reel 42 and the mat 40 will be separated from the remainder of the product on the conveyor 10, possibly by cutting the mat 40, and transported to another location. At this second location, the mat 40 will be cut, formed and exposed to high temperature and/or pressure, which melts the polypropylene fibers. The liquefied polypropylene flows around the fiberglass mat and cools to form an excellent composite with vastly improved surface quality over the prior art. The inventors theorize that this improved surface quality is due to the use of a continuous strand fiberglass mat rather than discontinuous glass fibers.

Each of the different devices in the workspace 12 can be located in different areas instead of the single workspace 12. Alternatively, additional steps for processing the mat 40 can be included in the process described above. For example, the mat 40 can be cut into discrete sections before being wound or otherwise packaged for transport to another site. Furthermore, the mat 40 can be conveyed directly into a cutting, shaping and molding stage that subjects the pieces to elevated temperature and pressure to melt the polypropylene fibers to form the composite.

Other fibers can be used in a reinforcing mat instead of the fiberglass reinforcing fibers described above. For example, woven roving materials, knitted fabrics, bi-axial and tri-axial fabrics, and any other engineered fabric can be used as the reinforcing fibers. These engineered fabrics can be made with any materials known to be useful as reinforcement fibers, including glass types A, E, C, ECR and S-type, carbon fibers, KEVLAR brand fibers or any other aramid materials and nylon fibers. All of these fibers and fiber types can comprise the reinforcing fibers in the reinforcing mat. It is contemplated that woven roving fibers will be useful if their size is between about 13 and 20 microns. However, it will become apparent to a person of ordinary skill that many factors will affect the fiber size, and, therefore, other fiber sizes will be considered appropriate in various circumstances.

The term “substantially planar structure of reinforcing fibers” is used herein to refer to mats, webs and other structures that are substantially planar, and that are made of fibers that are bound together in a manner that causes them to retain their substantially planar shape as a collective body. The manner by which the fibers are bound can include weaving, adhesive bonding, thermal bonding, and any other means. After needle-punching the thermoplastic fibers to such a planar structure, the thermoplastic fibers are held together and form a part of the mixed-fiber mat that results.

Although it is preferred to have first and second layers of polypropylene staple fibers sandwiching together a continuous strand fiberglass mat, it is possible to alter the number of layers by having only one layer of each or a plurality of layers of each. Additionally, the configuration can be altered, such as by sandwiching a single layer of staple polypropylene fibers between two or more layers of continuous strand fiberglass mat.

The compositions of mats can be varied widely, as will become apparent to a person having ordinary skill in the art. However, the inventor has found that mixtures of 70 (seventy) weight percent polypropylene fibers and 30 (thirty) weight percent glass fibers is a suitable blend, as is a blend of half by weight of each type of fiber. These blends are only given by way of example, and are not intended to limit the compositions of useful blends. Because the finished product will be a composite having characteristics that are suitable for the finished product, it will become apparent that these blends can be varied widely to achieve the desired characteristics in the finished product. Furthermore, any thermoplastic fiber can be used, because any such fibers will liquefy or soften upon heating, to permit flowing between the reinforcing fibers, and then harden again upon cooling.

Additionally, although it is preferred to use a continuous strand glass fiber mat in combination with staple polypropylene fibers, it is possible, in addition to the continuous strand glass fiber mat, to include a layer of glass fibers that are not from a continuous strand. This is especially desirable if one side of the finished product will be visible during normal operation, but the other side of the finished product will not be visible in normal operation. This could arise, for example, with an automobile fender which must have high surface quality on the upper surface, but can have low surface quality on the lower surface that is hidden, for example, in a wheel well.

One mixed fiber mat made according to the present invention is the mat 104 shown in FIG. 2. The mat 104 has a first layer 100 made of polypropylene fibers, and a second layer 102 made of a continuous strand glass fiber mat. The layers 100 and 102 are held together by the polypropylene fibers protruding into the interstices between the glass fibers.

Another mixed fiber mat made according to the present invention is the mat 118, which is shown in FIG. 3. The mat 118 has a first layer 110 made of polypropylene fibers, and a second layer 112 made of a continuous strand glass fiber mat. The third layer 114 is made of polypropylene fibers.

Yet another mixed fiber mat made according to the present invention is the mat 128, which is shown in FIG. 4. The mat 128 has a first layer 120 made of polypropylene fibers, and a second layer 122 made of a continuous strand glass fiber mat. The third layer 124 is made of polypropylene fibers, and the fourth layer 126 is made of discontinuous glass fibers. Such a mat 128 is used when one side of the finished product must have good surface qualities, and the opposite side does not have to have good surface quality.

The mixed fiber mats made according to the present invention can have various densities. The inventor has made mixed fiber mats according to the present invention in the range of between about 8 ounces per square yard and about 44 ounces per square yard, with about 15 ounces per square yard being a satisfactory mat. The glass fibers in the continuous strand fiberglass mats have diameters of about 16 to about 30 microns, with a diameter in the range of 24-25 microns being satisfactory. Of course, other densities and glass fiber diameters are possible, and the densities and diameters stated are not contemplated as being the only densities and fiber diameters that will work.

It will become apparent that any combination of thermoplastic fibers with one or more mats or webs of reinforcing fibers is useful according to the present invention. As another example, a polypropylene fiber layer may be placed on top of a woven roving, which is placed on top of a continuous strand glass fiber mat, which is placed on top of polypropylene fibers.

While certain preferred embodiments of the present invention have been disclosed in detail, it is to be understood that various modifications may be adopted without departing from the spirit of the invention or scope of the following claims.

1. A method of forming a mixed fiber mat, the method comprising:
(a) forming a multi-layer mat from a first substantially planar structure of reinforcing fibers and a first layer of thermoplastic fibers; and
(b) needle-punching the multi-layer mat to intertwine the fibers.

2. The method in accordance with claim 1, wherein the thermoplastic fibers further comprise polypropylene fibers and the substantially planar structure of reinforcing fibers further comprises a continuous strand glass fiber mat.

3. The method in accordance with claim 2, wherein the step of forming the multi-layer mat further comprises disposing staple polypropylene fibers on a first side of the continuous strand glass fiber mat.

4. The method in accordance with claim 3, wherein the step of forming the multi-layer mat further comprises disposing staple polypropylene fibers on a second side of the continuous strand glass fiber mat.

5. The method in accordance with claim 4, further comprising the step of forming at least one additional layer.

6. The method in accordance with claim 3, wherein the step of forming the multi-layer mat further comprises disposing a second continuous strand glass fiber mat on a side of the first layer of polypropylene fibers that is opposite the first continuous strand glass fiber mat.

7. The method in accordance with claim 3, wherein the step of forming the multi-layer mat further comprises disposing a second glass fiber mat on a side of the first layer of polypropylene fibers that is opposite the first continuous strand glass fiber mat.

8. The method in accordance with claim 3, wherein the step of forming the multi-layer mat further comprises disposing a plurality of staple glass fibers on a side of the first layer of polypropylene fibers that is opposite the first continuous strand glass fiber mat.

9. The method in accordance with claim 2, further comprising the steps of placing the multi-layer mat in a mold at sufficient pressure and temperature to melt the polypropylene fibers, and then cooling the multi-layer mat to a temperature sufficient to harden the melted polypropylene fibers.

10. The method in accordance with claim 1, wherein the thermoplastic fibers further comprise fibers selected from the group of acrylic-based fibers, nylon type fibers, polyester fibers, polyethylene fibers and bi-component fibers.

11. The method in accordance with claim 1, wherein the substantially planar structure of reinforcing fibers further comprises fibers selected from the group of type A glass fibers, type E glass fibers, type C glass fibers, type ECR glass fibers, type S glass fibers, carbon fibers, aramid type fibers and nylon fibers.

12. The mixed fiber mat produced according to the method of claim 1.

13. A mixed fiber mat comprising a first substantially planar structure of reinforcing fibers and a first layer of thermoplastic fibers needle-punched together to intertwine the fibers.

14. The mixed fiber mat in accordance with claim 13, wherein the thermoplastic fibers are staple polypropylene fibers and the substantially planar structure of reinforcing fibers further comprises a continuous strand glass fiber mat.

15. The mixed fiber mat in accordance with claim 14, wherein the layer of staple polypropylene fibers are disposed on a first side of the continuous strand glass fiber mat.

16. The mixed fiber mat in accordance with claim 15, further comprising staple polypropylene fibers disposed on a second, opposite side of the continuous strand glass fiber mat.

17. The mixed fiber mat in accordance with claim 16, further comprising at least one additional fiber layer.

18. The mixed fiber mat in accordance with claim 15, further comprising a second continuous strand glass fiber mat disposed on a side of the first layer of polypropylene fibers that is opposite the first continuous strand glass fiber mat.

19. The mixed fiber mat in accordance with claim 15, further comprising a second glass fiber mat disposed on a side of the first layer of polypropylene fibers that is opposite the first continuous strand glass fiber mat.

20. The mixed fiber mat in accordance with claim 15, further comprising a plurality of staple glass fibers disposed on a side of the first layer of polypropylene fibers that is opposite the first continuous strand glass fiber mat.

21. The method in accordance with claim 13, wherein the thermoplastic fibers further comprise fibers selected from the group of acrylic-based fibers, nylon type fibers, polyester fibers, polyethylene fibers and bi-component fibers.

22. The method in accordance with claim 13, wherein the substantially planar structure of reinforcing fibers further comprises fibers selected from the group of type A glass fibers, type E glass fibers, type C glass fibers, type ECR glass fibers, type S glass fibers, carbon fibers, aramid type fibers and nylon fibers.
